(19) United States
(12) Patent Application Publication
(10) Pub. No.: US 2003/0089355 A1
(43) Pub. Date: May 15, 2003

(54) Method for producing a sequence of high-voltage ignition sparks and high-voltage ignition device

(76) Inventors: Manfred Vogel, Ditzingen (DE); Werner Herden, Gerlingen (DE)

Correspondence Address: KENYON & KENYON, ONE BROADWAY, NEW YORK, NY, 10004, US

(21) Appl. No.: 10/203,059

(22) PCT Filed: Jan. 8, 2001
(86) PCT No.: PCT/DE01/00031

(30) Foreign Application Priority Data
Jan. 26, 2000 (DE) 100 03 109.9

(51) Int. Cl. F02P 3/02

(52) U.S. Cl. 123/620; 123/637

(57) ABSTRACT

A method of generating a sequence of high-voltage ignition sparks is described, wherein

an ignition energy storage device (2) is charged up to a specifiable charge state (I_{P, ZÜND}),

by a discharge of the ignition energy storage device (2), a spark is generated on an ignition spark generating means (6) connected to the ignition energy storage device (2),

a recharging operation of the ignition energy storage device (2) is started before the ignition energy storage device (2) is completely discharged, and

by discharging the ignition energy storage device (2), an additional ignition spark is generated on the ignition spark generating means (6).

The present invention relates to a method of generating a sequence of high-voltage ignition pulses and a high-voltage ignition device according to the preamble of claim 8.

### BACKGROUND INFORMATION

Various high-voltage ignition devices are known in the related art. In addition to inductive ignition, known systems also include capacitive ignition systems and a.c. ignition systems. Furthermore, there are known ignition systems in the related art in which a sequence of high-voltage ignition sparks is generated. This device, which is also known as double ignition, generates multiple ignition sparks during one combustion cycle in a cylinder in order to improve combustion. For this purpose, for example, there are known ignition systems having multiple ignition energy storage devices, e.g., ignition coils. The ignition spark sequence is controlled in time in the related art, this time control being implemented through software and/or hardware using a control unit. One disadvantage of the known multiple-spark systems is that there is a relatively long period of time between a charging and discharging operation of the ignition storage device. In addition, a greater material expenditure is necessary for ignition systems having multiple ignition energy storage devices.

### ADVANTAGES OF THE INVENTION

Using the method of generating a sequence of high-voltage ignition pulses having the features of claim 1 and using the high-voltage ignition device having the features of claim 8, it is possible in an advantageous manner to shorten the time between a discharging operation and a charging operation of an ignition energy storage device. This makes it possible to provide multiple high-voltage ignition sparks during one ignition cycle. However, it is also possible to reduce the capacitance of the ignition energy storage device due to the increase in the number of ignition sparks, i.e., for example, it is possible to use a smaller ignition coil in comparison with the related art. Essentially the shortening of the recharging time of the ignition energy storage device is achieved by recharging it before it is completely discharged. Thus, there remains a certain residual ignition energy in the ignition energy storage device, regardless of changes in such parameters as ignition voltage, operating voltage of the ignition spark, rotational speed of the internal combustion engine, ratio of the air-fuel mixture, battery voltage situation or the like, so that the recharging operation is shortened whereupon subsequent sparks may be generated at a much shorter interval after the first spark.

To prevent the ignition energy storage device from discharging completely by a simple method, in a refinement of the present invention, the ignition spark current is measured (while the ignition spark is burning) and when the ignition spark current drops below a specifiable value, the recharging operation of the ignition energy storage device is started. To prevent uncontrolled re-ignition on the ignition spark generating means which may be caused by current peaks in the ignition spark current, for example, in an especially preferred embodiment the recharging operation of the ignition energy storage device is started only when the ignition spark current has dropped below the specifiable value for a specified period of time. This also guarantees, however, a minimum spark duration, which will be necessary for ignition of the air-fuel mixture in the combustion chamber. Since restarting takes place only when the ignition spark current drops below the specifiable value, the short recharging time of the ignition spark storage device is also reached because residual ignition energy is available in the storage device.

If a measuring lead is provided from the ignition energy storage device to a control unit for an ionic current measurement, this measuring lead may be used to measure the ignition spark current. This also yields an inexpensive and robust implementation of control of the recharging operation by the control unit.

Additional advantageous embodiments are derived from the subclaims.

### DRAWING

The present invention is explained in greater detail below on the basis of embodiments with reference to the drawing.

FIG. 1 shows a first embodiment of a high-voltage ignition device;

FIG. 2 shows the charging current of an ignition energy storage device of the high-voltage ignition device, the ignition spark current, and a control voltage, all plotted over time;

FIG. 3 shows a second embodiment of a high-voltage ignition device; and

FIG. 4 shows the current and voltage curves over time of the high-voltage ignition device according to FIG. 3.

### DETAILED DESCRIPTION OF THE EXEMPLARY EMBODIMENTS

FIG. 1 shows a high-voltage ignition device 1 including an ignition energy storage device 2, a control unit 3 and a switching element 4. High-voltage ignition device 1 supplies electric power to a spark gap 5 to generate a high-voltage ignition spark. Spark gap 5 is formed on an ignition spark generating means 6, which may preferably be implemented as a spark plug.

In a preferred embodiment, ignition energy storage device 2 is designed as an inductor, i.e., as ignition coil 7 having a primary winding 8 and a secondary winding 9. Ignition spark generating means 6 is connected to secondary winding 9, an interference-suppression resistor 10 and a spark suppression diode 11 are also situated in this circuit, the anode being connected to spark gap 5 and the cathode being connected to secondary winding 9. Furthermore, bum-off resistor 12 of ignition spark generating means 6 and resistor 13 of ignition energy storage device 2 are also shown in this circuit. At one of its ends, secondary winding 9 is connected to spark gap 5, and at the other end of the winding it is connected to control unit 3.

At one of its ends, primary winding 8 is connected to a power supply voltage U_{B} which is, for example, the battery voltage of an onboard battery of a motor vehicle. The other end of primary winding 8 may be connected to ground via switching element 4. The power supply circuit for primary winding 8 is opened or closed, depending on how switching element 4 is triggered by control unit 3 via a control output 4′. When switching element 4 is closed, ignition energy storage device 2 is charged. After successful charging of ignition energy storage device 2, the stored ignition energy is dissipated through spark gap 5 by opening switching element 4, thereby discharging ignition energy storage device 2.

Control unit 3 has a voltage measuring input 14 which is connected to a voltage tap 15 which is situated between primary coil 8 and switching element 4 in the circuit on the primary side to measure bracket voltage of ignition energy storage device 2. Furthermore, control unit 3 has a current measurement input 16 which is connected to a current tap 17 of switching element 4. Primary current I_{P} is measured via this current measurement input 16, at least during the charging operation of ignition energy storage device 2. In addition, control unit 3 includes a determination device 19 which determines the charge state of energy storage device 2 at least during the generation of ignition sparks. To do so, in a preferred embodiment, the determination device has a current measurement input 20 which is connected to one end of secondary winding 9 to enable spark current I_{F} to be measured during generation of the ignition spark. To allow this to be implemented easily and simply, one terminal of a measuring shunt 21, also known simply as a shunt, is connected to the connecting line between current measuring input 20 and secondary winding 9, the other terminal of measuring shunt 21 being connected to ground 18. Finally, control unit 3 has a control input 22 to which a control voltage U_{E} may be applied, this voltage being output by a switching device.

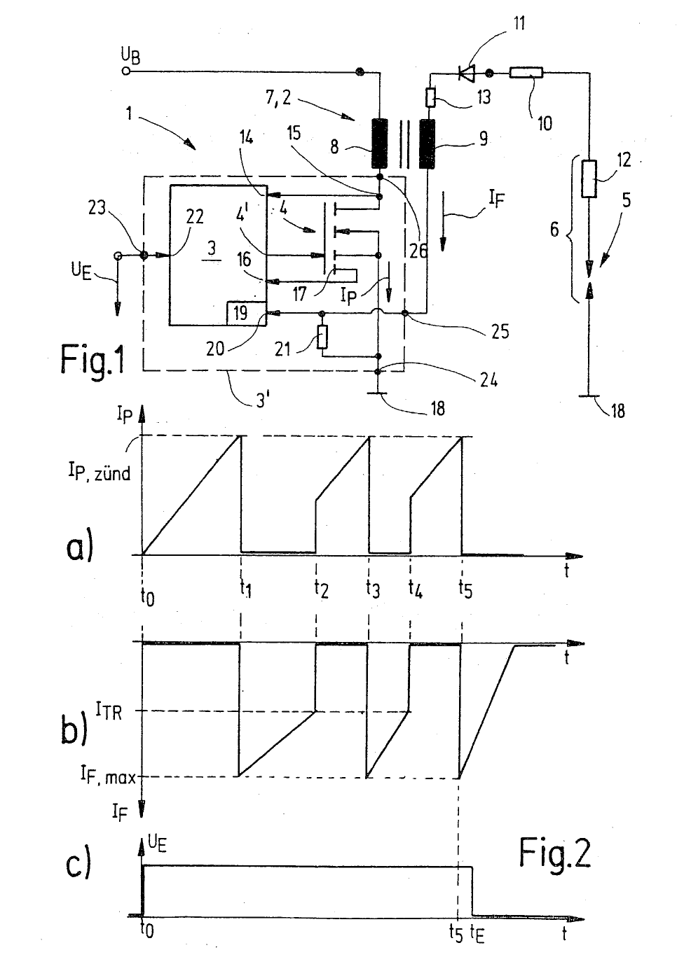

The functioning of high-voltage ignition device 1 is explained below on the basis of FIGS. 1 and 2a through 2c. When control input 22 is activated, control voltage U_{E} is applied during a period of time t₀ through t_{E} (FIG. 2c). Then control unit 3 triggers switching element 4 so that the power supply circuit for primary winding 8 is closed and primary current I_{P} increases after time t₀. Current I_{P} changes as a function of the charge state of ignition energy storage device 2. On reaching a specifiable value I_{P, ZÜND} at time t₁ switching element 4 is opened again via control unit 3 so that the subsequent discharging operation of ignition energy storage device 2 causes spark current I_{F} to increase at time t₁ (FIG. 2b) whereupon the ignition spark burns at spark gap 5. Spark current I_{F} drops due to the progressive discharge of ignition energy storage device 2. On reaching a specifiable trigger value I_{TR} of spark current I_{F} which is detected by determination device 19, switching element 4 is closed again by control unit 3 and a recharging operation of ignition energy storage device 2 is started at time t₂. The charging operation is implemented again until reaching value I_{P, ZÜND} which was determined for the primary current at time t₃, whereupon switching element 4 is opened again by control unit 3 so that a subsequent ignition spark is ignited by the discharge operation at spark gap 5 at time t₃ and burns until ignition spark current IF has dropped back to trigger value I_{TR} at time t₄, whereupon switching element 4 is closed again and another charging operation of the ignition energy storage device is carried out until the value of primary current I_{P} has again reached value I_{P, ZÜND} at time t₅. By opening switching element 4 again, a discharging operation of ignition storage device 2 takes place again which in turn generates an ignition spark at time t₅ at spark gap 5. However, triggering voltage U_{E} at time t_{E} is no longer applied to control output 22 so that control unit 3 does not close switching element 4 again and the ignition spark burns out completely. It is thus readily apparent that depending on triggering time t₀ through t_{E} at time t₁ an initial spark may be generated, in period of time t₂ through t₄ at least one or more subsequent sparks may be generated, and at time t₅ a concluding ignition spark, which may burn out, is generated.

To prevent uncontrolled charging or discharging of the ignition energy storage device between two ignition sparks, e.g., in period of time t₂ to t₃, switching element 4 is closed for a charging operation of ignition storage device 2 only when ignition spark current I_{F} has dropped below trigger value I_{TR} for a certain period of time, e.g., 20 μs to 80 μs, so that current peaks are more or less filtered out and are not taken into account in triggering switching element 4. Trigger value I_{TR} is lower than maximum current I_{F,max} and may amount to 0.3 to 0.7 times maximum spark current I_{F,max}, for example. This trigger value I_{TR} is thus variable, preferably as a function of at least one operating parameter of the engine. For example, the rotational speed and/or the engine load may be used for this purpose. In particular, a characteristics map field is available containing several characteristic curves so that trigger value I_{TR} may be selected as a function of these operating characteristic curves of the engine. By changing trigger value I_{TR}, the duration of a single spark changes, and thus the number of sparks for a spark sequence may be changed.

FIG. 1 also shows that both control unit 3 and measuring shunt 21 as well as switching element 4, which is designed as a power switch in particular, may be manufactured inexpensively as unit 3′ on a semiconductor substrate, so that only four terminals 23 through 26 need lead out of a housing accommodating this substrate. Of course control unit 3, measuring shunt 21 and switching element 4 may also be designed as separate components, which, however, may also be situated in a single housing having terminals 22 through 26.

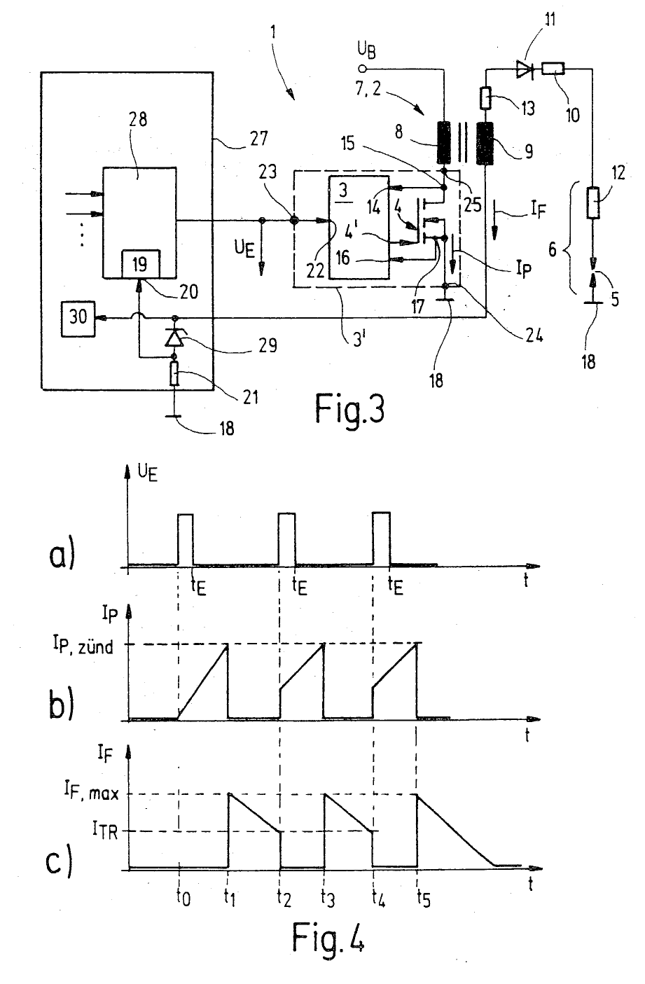

FIG. 3 illustrates a second embodiment of a high-voltage ignition device 1 in which determination device 19 is implemented in a switch unit 27 upstream from control unit 3, including a switch device 28 whose output end is connected to control input 22 of control unit 3 and which supplies control voltage U_{E} for control unit 3. Control voltage U_{E} is provided in pulse form according to FIG. 4a, namely as a function of spark current I_{F}. If this spark current I_{F} reaches trigger value I_{TR} (FIG. 4c) a control voltage pulse U_{E} is again applied to control input 22 so that control unit 3 closes switching element 4 until primary current I_{P} has reached ignition value I_{P, ZÜND} (FIG. 4b) whereupon switching element 4 is opened again so that by discharging spark energy storage device 2 a spark may again be supplied at spark gap 5. It is an advantage of this method of supplying control voltage U_{E} that only three terminals 23, 24 and 25 must lead out of housing which holds unit 3′ having control unit 3 and switching element 4.

In this embodiment of high-voltage ignition device 1 according to FIG. 3, current measuring input 20 is tapped between a Zener diode 29 and measuring shunt 21, Zener diode 29 being connected in the forward direction for spark current I_{F}. The connecting line between secondary winding 9 and Zener diode 29 is continued up to an ionic current measuring device 30 with which the ionic circuit in the combustion chamber may be measured during ignition spark pauses to permit an evaluation of the knock characteristics of the engine, for example. Otherwise the same parts or those having the same effect as in FIGS. 1 and 2 are provided with the same reference notation in FIGS. 3 and 4. To this extent, reference is made to the description of these figures.

High-voltage ignition device 1 thus implements a means of multiple charging and discharging of ignition energy storage device 2, whereby, in order to reduce the pause times between two ignition sparks, the charging time is greatly shortened with respect to known systems for recharging ignition energy storage device 2 because residual energy always remains in ignition energy storage device 2. Thus it is possible to use inexpensive ignition energy storage devices, in particular coils having a primary energy of <100 mJ. By changing trigger value I_{TR} for the spark current and changing shutdown current I_{P, ZÜND}, it is also possible to achieve an adaptation to the respective power supply voltage level in particular the charge state of the onboard battery. Furthermore, the duration of a spark sequence or the number of sparks during a spark sequence, may be varied.

The adjustment of the discharge time of the ignition energy storage device may also be adapted to the conditions in the secondary circuit of ignition energy storage device 2 and ignition spark generating means 6 so that tolerances in resistors 12, 10 and 13 in the secondary circuit may be compensated.

What is claimed is:

1. A method of generating a sequence of high-voltage ignition sparks, in which
an ignition energy storage device (2) is charged up to a specifiable charge state (I_{P, ZÜND}),
by a discharge of the ignition energy storage device (2), a spark is generated on an ignition spark generating means (6) connected to the ignition energy storage device (2),
a recharging operation of the ignition energy storage device (2) is started before the ignition energy storage device (2) is completely discharged, and
by discharging the ignition energy storage device (2), an additional ignition spark is generated on the ignition spark generating means (6).

2. The method according to claim 1,
wherein the ignition spark current (I_{F}) is measured during the generation of ignition sparks, and the recharging operation of the ignition energy storage device (2) is started when the ignition spark current (I_{F}) drops below a specifiable value (I_{TR}).

3. The method according to claim 1 or 2,
wherein the recharging operation of the ignition energy storage device (2) is started when the ignition spark current (I_{F}) has dropped below the specifiable value (I_{TR}) for a specifiable period of time.

4. The method according to one of the preceding claims,
wherein at least one charging operation, one recharging operation, and one complete discharging operation of the ignition energy storage device (2) take place within one combustion cycle.

5. The method according to one of the preceding claims,
wherein the number of recharging operations within a combustion cycle is determined as a function of operating parameters of the internal combustion engine.

6. The method according to one of the preceding claims,
wherein an ionic current measurement is performed during an ignition spark pause and, depending on the parameters determined from the ionic current measurement, the starting time of the recharging operation of the ignition energy storage device (2) is selected.

7. The method according to one of the preceding claims,
wherein the trigger value (I_{TR}) for the ignition spark current (I_{F}) is variable as a function of at least one operating parameter, in particular the rotational speed and/or the load of the internal combustion engine.

8. A high-voltage ignition device for generating a spark sequence, having an ignition energy storage device, a switching element for the ignition energy storage device which connects a power supply device to and disconnects it from the ignition energy storage device, and a control unit for triggering the switching element,
characterized by a determination device (19) for the charge state (I_{P, ZÜND}) of the ignition energy storage device (2), the control unit (3) reclosing the switching element (4) when the charge state of the ignition energy storage device (2) drops below a specifiable level and the switching element (4) is reopened when a specifiable charge state is reached again.

9. The high-voltage ignition device according to claim 8,
wherein the determination device (19) is a current measuring device for the spark current (I_{F}).

10. The high-voltage ignition device according to claim 8,
wherein the ignition energy storage device (2) is an inductor.

11. The high-voltage ignition device according to one of claims 8 or 9,
wherein the control unit (3) has the determination device (19).

12. The high-voltage ignition device according to claim 8,
wherein the switching element (4) is a semiconductor switching element.

13. The high-voltage ignition device according to one of claims 8 through 12,
wherein the semiconductor switching element and the control unit (3) are situated on a common substrate.

14. The high-voltage ignition device according to one of the preceding claims 8 through 13, characterized by an ionic current measuring device (30).
